(19) United States
(12) Patent Application Publication
(10) Pub. No.: US 2013/0173697 A1
(43) Pub. Date: Jul. 4, 2013

(54) METHOD AND DEVICE FOR FILE RECEIVING AND SENDING

(71) Applicants: Fu Tai Hua Industry (Shenzhen) Co., Ltd., Shenzhen (CN); Hon Hai Precision Industry Co., Ltd., New Taipei (TW)

(72) Inventor: PENG WANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/726,233

(22) Filed: Dec. 24, 2012

(30) Foreign Application Priority Data
Dec. 30, 2011 (CN) 201110453015.X

(51) Int. Cl. H04L 29/08

(52) U.S. Cl. CPC H04L 67/06
USPC 709/203

(57) ABSTRACT

A file receiving and sending method, comprising steps of: reading an object file to be sent; cutting the object file into a number of sub-files and sequencing the sub-files with a given order; sending the sequenced sub-files in order via a network; receiving the sequenced sub-files via the network; combining the received sub-files one by one according to their given order; displaying the combined file as the first, and as each further sub-file, is received; determining whether to continue receiving remaining sub-files according to user's input. Users are able to preview part content of the object file and determine whether to continue or to stop receiving the whole file as they like.

### BACKGROUND

1. Technical Field

The present disclosure relates to Instant Messaging (IM) technology and particularly to a method and a device for file receiving and sending based on IM server.

2. Description of Related Art

User sends and receives an instant message or a multimedia file such as a picture, a voice file, a video file and a text file between client devices, such as a personal computer, personal digital assistant, or mobile phone. A Multimedia Message Service (MMS) and a Multimedia Message Service Center (MMSC) are supplied by a telecom carrier to transmit the instant message or the multimedia file, the allowed capacity of the MMSC per message is generally 30 Kbytes (KB), but the client devices such as cell phones are capable of receiving a multimedia file with size of 30 KB˜60 KB, in particular a smart phone may be capable of receiving a file with size of about 100 KB.

Users can chose other methods to transmit the instant message or the multimedia file, such as transmission modes based on Bluetooth, infrared or internet, and there is no limit to the size of the file in those modes. However, the transmitted instant message or multimedia file cannot be read until the transmission of the whole file is completed. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a file receiving and sending system, according to a first embodiment.

FIG. 2 is a block diagram illustrating a file sending device of the file receiving and sending system of FIG. 1.

FIG. 3 is a block diagram illustrating a file receiving device of the file receiving and sending system of FIG. 1.

FIG. 4 is a flowchart of a file receiving and sending method, in accordance with the first embodiment.

FIG. 5 is a schematic view of a file receiving and sending system, according to a second embodiment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

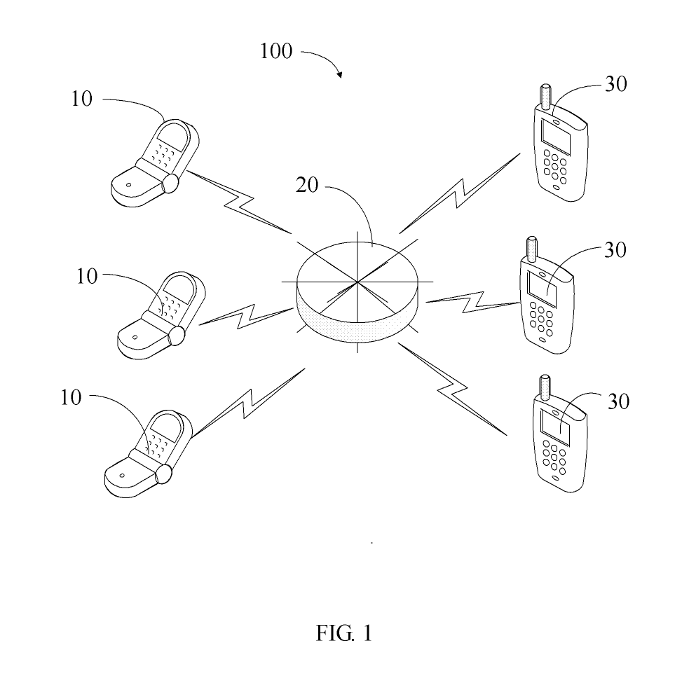

FIG. 1 shows a file receiving and sending system 100 according to a first embodiment. The file receiving and sending system 100 includes a number of file sending devices 10 and a number of file receiving devices 30. The file sending devices 10 are capable of communicating with the file receiving device 30 via a network 20. In the embodiment, a one-to-one transmitting mode is illustrated as an example, that is to say, each of the file sending devices 10 communicates with one of the file receiving devices 30, to directly transmit an instant message or a multimedia file. In other embodiments, one of the file sending devices 10 communicates with one or more file receiving devices 30 to transmit files

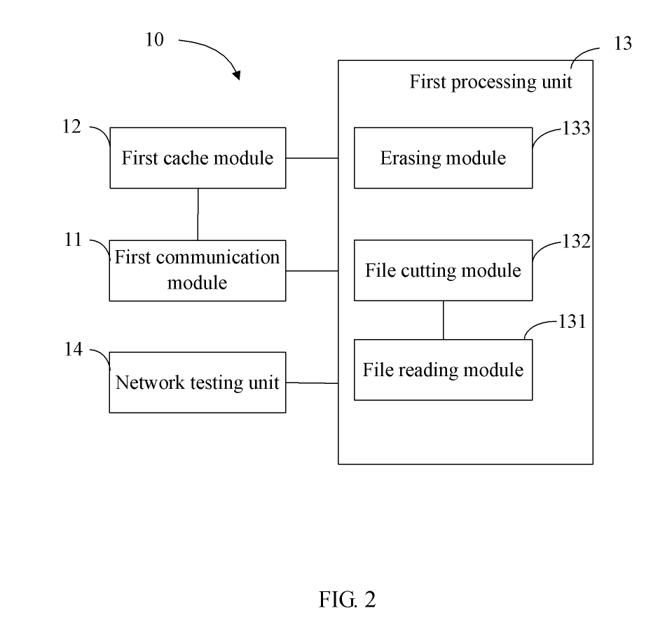

Referring to FIG. 2, the file sending device 10 can be an electronic terminal such as cell phone, Personal Digital Assistant (PDA), notebook, or a message distribution device of the Multimedia Message Service Center (MMSC) supplied by the telecom carrier or the like. In this embodiment, the file sending device 10 is a cell phone, the file sending device 10 is capable of sending a number of multimedia files such as a picture, a voice file, a video file and a text file. The file sending device 10 includes a first communication module 11, a first cache module 12 and a first processing unit 13. The file sending device 10 connects to the network 20 via the first communication module 11, to communicate with the file receiving device 30. The first processing unit 13 includes a file reading module 131, a file cutting module 132 and an erasing module 133.

The file reading module 131 reads an object file to be sent. The file reading module 131 reads the object file in a storage unit (not shown) of the file sending device 10 if the file sending device 10 is an electronic terminal. If the file sending device 10 is the message distribution device of the MMSC supplied by the telecom carrier, the file reading module 131 reads the object file in a file server (not shown) of the MMSC.

The file cutting module 132 cuts the object file into a number of sub-files and sequences each sub-file with a given order. The first cache module 12 is configured to store the number of sub-files. The file cutting module 132 cuts the object file into a number of sub-files each having a file size customized according to a transmission rate of the network 20, the term “file size” meaning a maximum size of a single sub-file as defined by users or by the system, based on the present transmission rate of the network 20.

Taking an example, the network 20 is a third-generation (3G) mobile communication network, and the file size is 2 Mbytes (MB) while the transmission rate is 500 Kbps˜1.5 Mbps; if the present transmission rate is 1 Mbps, a 20 MB object file will be cut into 10 sub-files, each sub-file thus has a size of 2 MB; a 19 MB object file will also be cut into 10 sub-files, wherein each of the 9 sub-files has a size of 2 MB and 1 sub-file has a size of only 1.9 MB; if the file size is 5 MB while the transmission rate is 1.5 Mbps 3 Mbps, and the present transmission rate is 2 Mbps, a 20 MB object file will be cut into 4 sub-files, each sub-file having a size of 5 MB.

In another example, the network 20 is a global system for mobile communications (GSM) network and the file size is 0.4 MB, so if the present transmission rate is 170 Kbps, a 20 MB object file will be cut into 50 sub-files, each sub-file having a size of 0.4 MB.

The first communication module 11 sends the sequenced sub-files stored in the first cache module 12 to the file receiving device 30, in turn, via the network 20. At the same time, the erasing module 133 erases the sent sub-files stored in the first cache module 12.

The file sending device 10 further includes a network testing unit 14 which tests whether the network 20 is working correctly. The network testing unit 14 generates a signal indicating a break (broken signal) when the network 20 is interrupted or is subject to an error condition. The first communication module 11 suspends sending further sequenced sub-files to the file receiving device 30 in response to the broken signal until the network 20 resumes normal working.

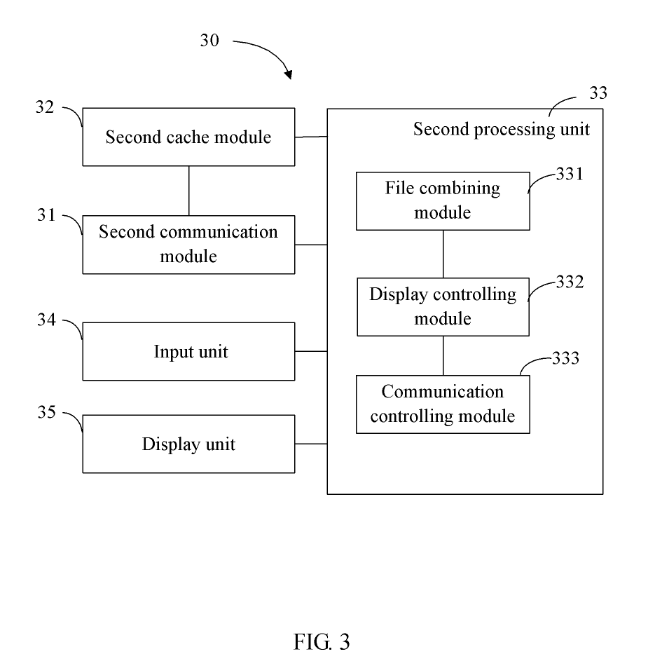

Referring to FIG. 3, the file receiving devices 30 can be an electronic terminal such as cell phone, PDA, notebook, or a message distribution device of the Multimedia Message Service Center (MMSC) supplied by the telecom carrier or the like. In this embodiment, the file receiving device 30 is a cell phone, the file receiving device 30 is capable of receiving multimedia files sent by the file sending device 10. The file receiving device 30 includes a second communication module 31, a second cache module 32, a second processing unit 33 and an input unit 34 and a display unit 35. The file receiving device 30 connects to the network 20 via the second communication module 31, allowing communication with the file sending device 10. The second processing unit 33 includes a file combining module 331, a display controlling module 332 and a communication controlling module 333.

The second communication module 31 receives the sequenced sub-files sent by the first communication module 11 of the file sending device 10 via the network 20, the received sub-files are stored according to the given order in the second cache module 32.

The file combining module 331 combines the received sub-files stored in the second cache module 32 according to the given order, and the display controlling module 332 controls the display unit 35 to display the combined file. As the second communication module 31 continues to receive sequenced sub-files, the file combining module 331 continues to add newly received sequenced sub-files to the combined file to produce a new combined file, and the display controlling module 332 updates the display file by replacing the combined file with the new combined file. The receiving, storing, combining and updating processing continues until the last sub-file is combined with all the earlier sub-files to recover the whole object file, and the whole new object file is then displayed to the receiving device in place of the old combined file. Such a repeated receiving, storing, combining and updating process allows the object file to be gradually recovered and shown immediately, in incomplete stages, on the display unit 35.

The communication controlling module 333 switches the second communication module 31 to continue receiving the sub-files transmitted via the network 20 or to stop receiving the sub-files. The object file is gradually combined during the receiving process, users can preview increasing portions of the whole object file and determine whether to continue or to stop receiving the remaining sub-files.

The input unit 34 responds to user's input and generates signals from the input. Users can input a stop command via the input unit 34, the input unit 34 responds to the stop command and generates a stop signal. The communication controlling module 333 responds to the stop signal and switches the second communication module 31 to stop receiving further sub-files from the network 20.

In this embodiment, the first communication module 11 and the second communication module 31 are 3 G communication modules, and the network 20 is a 3G mobile communication network. In other embodiments, the network 20 is a wired or wireless network base on BLUETOOTH, INFARED or INTERNET, and the first communication module 11 and the second communication module 31 are communication modules consistent with the network 20.

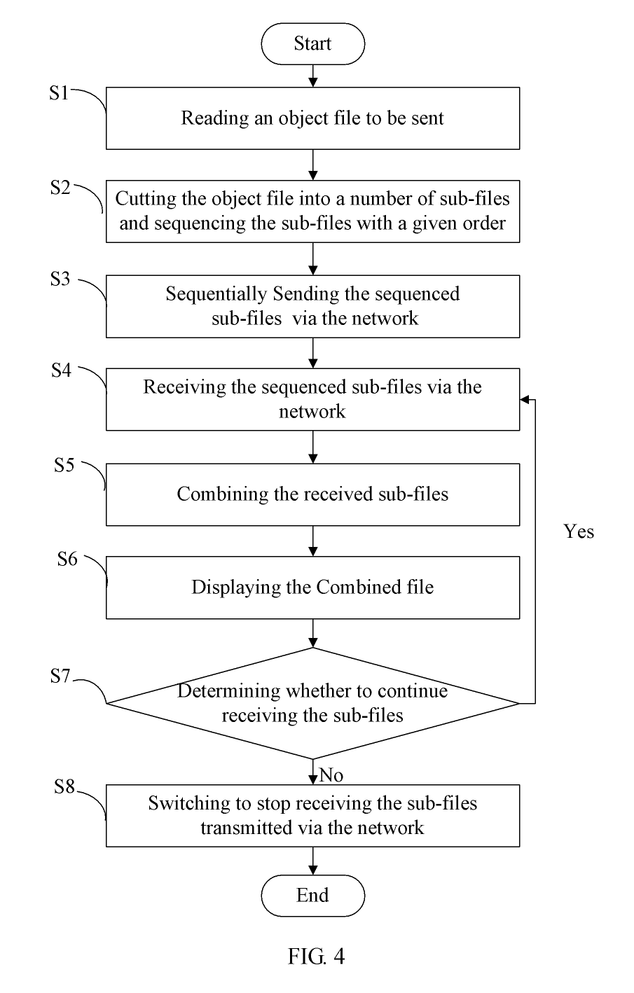

FIG. 4 shows a flowchart of a file receiving and sending method of the file receiving and sending system 100 in the first embodiment. The method includes the following steps, each of which is tied to various components contained in the electronic device 100 as shown in FIGS. 2 and 3:

In step S1, reading an object file to be sent. The file reading module 131 of the file sending device 10 reads the object file in the storage unit.

In step S2, cutting the object file into a number of sub-files and sequencing the sub-files win a given order. The file cutting module 132 cuts the object file into a number of sub-files and sequences each sub-file in a given order.

In step S3, sequentially sending the sub-files in the given order via the network. The first communication module 11 sequentially sends the sequenced sub-files to the file receiving device 30 via the network 20.

In step S4, receiving the sub-files via the network. The second communication module 31 receives the sub-files sent by the first communication module 11 of the file sending device 10 via the network 20.

In step S5, combining the received sub-files according to the given order. The file combining module 331 combines the received sub-files one by one according to the given order.

In step S6, displaying the combined file. The display controlling module 332 controls the display unit 35 to display the combined file as soon as the first sub-file has been received.

In step S7, determining whether to continue receiving remaining sub-files according to user's input; if to continue, then step S4 takes place; if not to continue, the procedure goes to step S8. The input unit 34 responds to any stop command input by users and generates a stop signal accordingly.

In step S8, the device stops receiving the sub-files transmitted via the network 20. The communication controlling module 333 responds to a stop signal and switches the second communication module 31 to stop receiving further sub-files transmitted via the network 20.

In other embodiments, step S2 further includes step of storing the sub-files in the first cache module 12 in the given order; the step S3 further includes step of erasing the copies of the sent sub-files which were stored in the first cache module 12; and the step S4 further includes step of storing the received sub-files in the second cache module 32 in accordance with the given order.

With such a file receiving and sending system 100 and the method thereof, users can preview a portion of the final object file and determine whether to continue or to stop receiving further sub-files as they like.

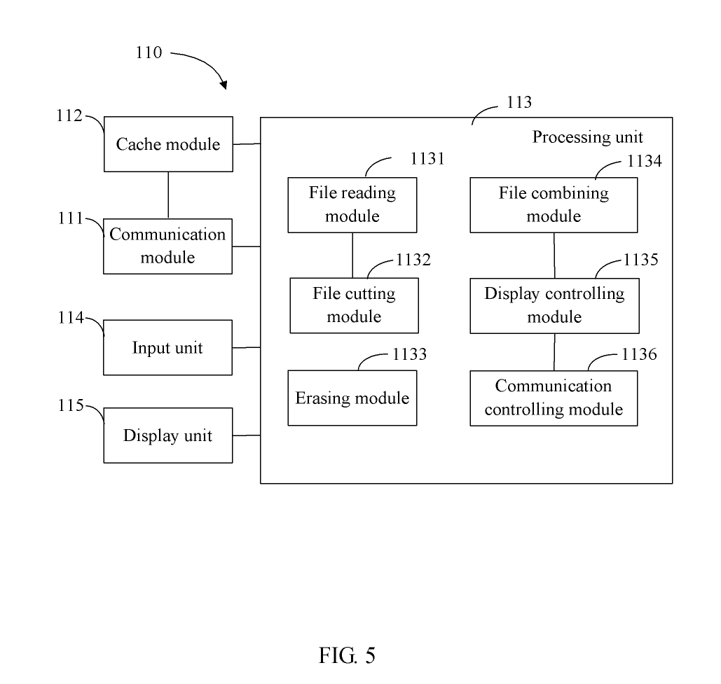

FIG. 5 shows a file receiving and sending device 110 in a second embodiment. The file receiving and sending device 110 have both the file sending device 10 and the file receiving device 30.

The file receiving and sending device 110 includes a communication module 111, a cache module 112, a processing unit 113, an input unit 114 and a display unit 115. The processing unit 113 includes a file reading module 1131, a file cutting module 1132, an erasing module 1133, a file combining module 1134, a display controlling module 1135 and a communication controlling module 1136.

The file reading module 1131 reads an object file to be sent, the file cutting module 1132 cuts the object file into a number of sub-files and sequences the sub-files into a second given order. The communication module 111 sends the sequenced sub-files to a receiving terminal or to an electronic device in the second given order via the network 20, the erasing module 1133 erases the copies of the sent sub-files in the cache module 112 as each sub-file is sent.

The communication module 111 further receives a number of incoming sub-files transmitted and from a sending device terminal via the network 20 in a first given order. The file combining module 1134 combines the received sub-files according to the second given order, and the display controlling module 1135 displays the combined file. Users can input a stop command via the input unit 114, which generates a stop signal. The communication controlling module 1136 responds to stop signal and controls the communication module 111 to stop receiving incoming sub-files transmitted via the network 20.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A file receiving and sending method, comprising:
S1, reading an object file to be sent;
S2, cutting the object file into a number of sub-files and sequencing the sub-files in a given order;
S3, sequentially sending the sub-files in the given order via a network;
S4, receiving the sub-files via the network;
S5, combining the received sub-files according to the given order;
S6, displaying the combined file;
S7, determining whether to continue receiving remaining sub-files according to user's input, if to continue, step S4 takes place; if not to continue, goes to step S8; and
S8, stopping receiving sub-files from the network.

2. The method as described in claim 1, wherein the step S2 further comprises step of storing the sub-files in the given order.

3. The method as described in claim 1, wherein the step S3 further comprises step of erasing copies of the sent sub-files.

4. The method as described in claim 1, wherein the step S4 further comprises step of storing the received sub-files in accordance with the given order.

5. A file receiving device comprising:
a display unit;
an input unit configured for responding user's input of a stop command and generating a stop signal associated therewith;
a communication module configured for sequentially receiving a plurality of sub-files sent by a file sending device in a given order; and
a processing unit comprising:
a file combining module configured for combining the received sub-files according to the given order;
a display controlling module configured for controlling the display unit to display the combined file; and
a communication controlling module configured for controlling the communication module to stop receiving sub-files from the network in response to the stop signal.

6. The file receiving device as described in claim 5, wherein the file receiving device is a cell phone, a PDA or a notebook.

7. A file receiving and sending device comprising:
a display unit;
a processing unit comprising:
a file reading module configured for reading an object file to be sent; and
a file cutting module configured for cutting the object file into a plurality of sub-files;
a communication module configured for sending the sub-files to a file receiving device via a network, the communication module further configured for sequentially receiving a plurality of incoming sub-files sent by and from a file sending device in a first given order; and
an input unit configured for responding user's input of a stop command and generating a stop signal associated therewith;
wherein the processing unit further comprises:
a file combining module configured for combining the received incoming sub-files according to the first given order;
a display controlling module configured for controlling the display unit to display the combined file; and
a communication controlling module configured for controlling the communication module to stop receiving further incoming sub-files transmitted via the network.

8. The file receiving and sending device as described in claim 7, wherein the file cutting module is configured to cut the object file into the plurality of sub-files and further sequence the sub-files in a second given order, the communication module is configured to sequentially send the sub-files in the second given order via the network.

9. The file receiving and sending device as described in claim 8, wherein the file cutting module is configured to cut the object file into the plurality of sub-files each having a file size customized according to a transmission rate of the network.

10. The file receiving and sending device as described in claim 7, further comprising:
a cache module configured for storing the sub-files cut by the file cutting module and storing the sub-files received by the communication module;
an erasing module configured for erasing copies of the sent sub-files stored in the cache module.

11. The file receiving and sending device as described in claim 7, wherein the file receiving device is a cell phone, a PDA or a notebook.
